(19) United States
(12) Patent Application Publication
(10) Pub. No.: US 2007/0262004 A1
(43) Pub. Date: Nov. 15, 2007

(54) Water Treatment Apparatus

(76) Inventors: George R. Jordan, Chardon, OH (US); Steven M. Hoopes, Warren, OH (US)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 11/667,151

(22) PCT Filed: Nov. 4, 2005
(86) PCT No.: PCT/US05/40178

§ 371 Date: May 4, 2007

Related U.S. Application Data
(60) Provisional application No. 60/625,541, filed on Nov. 5, 2004.

(51) Int. Cl. B01D 21/30; B01D 27/10; B01D 29/88; C02F 1/44

(52) U.S. Cl. 210/110; 210/133; 210/136; 210/321.72; 210/97

(57) ABSTRACT

A water treatment apparatus which facilitates the installation of a water treatment unit and prefilter into an existing plumbing system. The apparatus includes a bypass valve interconnected with a prefilter and water treatment unit using a connection box. The fittings and orientations are chosen for the components so that various configurations and orientations can be easily accommodated and with a minimum of parts. The apparatus eliminates the need for fabricating conduit segments, etc. at the installation site. The apparatus for connecting a water treatment unit to a water distribution system includes a control valve having spaced apart inlet and outlet ports and a connection module defining first and second flow passages. The first flow passage extends between first and second external ports and the second flow passage extends between third and fourth external ports. The first and third external ports are arranged and configured to correspond to the configuration and. spacing of the control valve inlet and outlet ports. A filter unit includes inlet and outlet ports that are configured and oriented to correspond to the configuration and spacing of the control valve inlet and outlet ports. The filter includes a filter head and a sump releasably coupled to the head. The sump at least partially defines a filter chamber containing a replaceable filter element. A cup seal seals the interface between the head and the sump and includes a sealing lip that is urgent to sealing engagement with a filter chamber wall by water pressure. At predetermined lower water pressures the sealing engagement between the seal and the chamber wall is reduced to enable the sump to be decoupled using hand manipulation. At least one of the filter ports is swivelly connected to the head to enable the orientation of the port to be changed.

### TECHNICAL FIELD

The present invention relates generally to fluid treatment systems and, in particular, to a method and apparatus that facilitates installation of a fluid treatment system that includes a fluid treatment unit and prefilter.

### BACKGROUND ART

It has become common, especially in some areas of the country, to use water treatment devices to filter or treat all or portions of the water used by a household or business. In the case of household water supplies, treatment devices for softening water, removing mineral content, and other impurities, are becoming more and more commonplace. In addition, treatment devices, such as reverse osmosis units, are becoming popular and operate to filter or purify a portion of the water supply that is intended to be consumed.

When these types of water treatment devices, i.e., water softeners, are installed, the installer must fabricate plumbing connections between the existing household plumbing conduits and the device. It can become even more complicated when auxiliary components, such as bypass valves, and auxiliary filters, need be plumbed as part of the installation. It has been found that considerable installer time can be expended in creating the plumbing interconnections. In some cases the plumbing connections are very complicated and costly and may compromise the ability to service the device in the future.

### DISCLOSURE OF THE INVENTION

The present invention provides a new and improved method and apparatus for integrating a water treatment apparatus into an existing water distribution system.

According to the invention, a bypass valve, prefilter, and water treatment unit are interconnected with each other and the existing water supply conduits. The components are easily interconnected in various configurations to accommodate the orientation of the existing plumbing system. The prefabricated connection components can be brought to an installation site and assembled in alternate configurations to accommodate the existing plumbing connections.

In accordance with a preferred embodiment of the invention, an apparatus is disclosed for connecting a water treatment unit to a plumbing or fluid distribution system. The apparatus includes a control valve for controlling the operation of the fluid treatment unit; the control valve has spaced apart inlet and outlet ports. A filter unit forms part of the apparatus and includes spaced apart inlet and outlet ports, the spacing and configuration of the filter ports corresponding to the configuration and spacing of the control valve inlet and outlet ports. A connection element or module establishes fluid communication between the filter unit and the control valve and defines first and second isolated flow passages. The first flow passage extends between first and second external ports forming part of the connection element and the second flow passage extends between the third and fourth external ports. In accordance with the invention, the first and third external ports are configured and oriented to correspond to the configuration spacing of the control valve inlet and outlet ports.

According to a feature of this embodiment, a bypass valve having at least two ports configured and oriented to correspond to the configuration and spacing of the control valve inlet and outlet ports also forms part of the apparatus. In a more preferred embodiment, the connection element includes structure for releasably coupling the first and third ports to the filter unit or to the water treatment unit.

According to another embodiment of the invention, the apparatus for connecting the water treatment unit to the plumbing system includes a bypass valve having spaced apart water input and output ports. The apparatus also includes a prefilter having spaced apart inlet and outlet ports with the spacing and configuration of these ports corresponding to the configuration and spacing of the bypass valve input and output ports. The apparatus also includes the connection element that has first and third external ports configured and oriented to correspond to the configuration and spacing of the prefilter ports.

According to another embodiment of the invention, the connecting apparatus includes a control valve, a bypass valve and a connection element. In this embodiment, the connection element has first and third external ports that are configured and oriented to correspond to the configuration spacing of inlet and outlet ports forming part of the control valve.

According to a feature of the invention, the connection element may include at least one, but preferably two, auxiliary ports that communicate with the first and second flow passages. According to a feature of this embodiment, at least one of the auxiliary ports can serve as a source connection for a reverse osmosis unit or other device such as a tank, etc. According to another feature of this embodiment, one or both of the auxiliary ports can receive a pressure gauge connection to monitor pressure in one or both of the flow passages. When pressure gauges are connected to both auxiliary ports, a pressure drop between the first and second flow passages may be monitored.

In accordance with the invention, a connection module is disclosed for establishing fluid communication between a water treatment control valve having spaced apart inlet and outlet ports and another device forming part of the water treatment system. The connection module includes a housing defining first and second isolated flow passages. The first flow passage extends between external first and second ports and the second flow passage extends between third and fourth external ports. The first and third ports are spaced apart and oriented to correspond to the configuration and spacing of the control valve inlet and outlet ports and/or the other device. The second and fourth ports are oriented such that the ports lie on coincident axes. In a more preferred embodiment of the connection module, the first and third ports lie on axes that are substantially orthogonal to the axes of the second and fourth ports. According to another feature of this embodiment, the connection module includes first and second auxiliary ports that communicate with the first and second flow passages, respectively.

In the exemplary embodiment, at least some of the external ports of the connection module have structure for releasably coupling the ports to the other device. The other device may be a prefilter having inlet and outlet ports that are configured and oriented to correspond to the control valve inlet and outlet ports. The control valve may form part of a treatment unit or in an alternate embodiment, the control valve may be a bypass valve.

According to another aspect of the invention, a filter unit for a water treatment system is disclosed that includes a filter head having inlet and outlet ports. A sump is releasably coupled to the head and at least partially defines a filter chamber when the sump is coupled to the head. A replaceable filter element is located within the filter chamber. A cup seal is used to seal the interface between the head and the sump and includes a lip that is urged into sealing engagement by fluid (i.e. water) pressure within the filter chamber. Preferably, the lip of the cup seal is arranged such that water pressure in the filter chamber tends to urge the lip radially outwardly in order to increase the sealing engagement with a filter chamber wall. According a feature of this embodiment of the invention, the lip substantially releases its sealing engagement at lower water pressures to enable the sump to be decoupled using hand manipulation.

According a further feature of this embodiment, the filter inlet and outlet ports are chosen such that the configuration and spacing of the ports corresponds to the configuration and spacing of ports defined by at least one other device in the water treatment system. The device may comprise a connection module and/or a control valve forming part of the treatment system. According a further aspect of this embodiment, at least one of the ports is rotatable with respect to the head in order to change its orientation with respect to the other port.

According to a preferred embodiment of the invention, the connection box defines fittings and fitting orientations which facilitate the interconnection between the bypass valve, the prefilter, and a control valve forming part of the water treatment unit. By selectively choosing the fitting spacings and orientations on the connection box, the fabrication of specialized conduit segments and conduit connections is substantially eliminated. In the preferred and illustrated embodiment, the connection between the components is achieved using a E-ring type locking mechanism in which a resilient E-ring is used to lock together a connection made between a male fitting, including sealing O-rings and a female fitting that slidably receives the male fitting. After the male fitting is inserted into the female fitting, the locking ring is installed and locking tabs forming part of the locking ring extend through apertures in the female fitting and engage a locking groove formed in the male fitting. The engagement of the locking tabs with the groove inhibits separation of the male fitting from the female fitting, while allowing easy disassembly of the fitting when required.

With the present invention, a kit of parts can be supplied as part of the apparatus or system which the installer then uses in various combinations in order to install the apparatus and which accommodates the existing plumbing connections.

Additional features of the invention will become apparent and a fuller understanding obtained by reading the following detailed description made in connection with the accompanying drawings.

### BRIEF DESCRIPTION OF THE DRAWINGS

FIG. 1 is a perspective view of a water treatment apparatus constructed in accordance with a preferred embodiment of the invention;

FIG. 2 is a perspective view of a alternate configuration of the water treatment apparatus constructed in accordance with the preferred embodiment of the invention;

FIG. 3 is an exploded view of the apparatus shown in FIG. 1;

FIG. 4 is an exploded view of the apparatus shown in FIG. 2;

FIG. 5 is an exploded view of a connection element or module constructed in accordance with the preferred embodiment of the invention;

FIG. 6A is a top plan view of the connection box;

FIG. 6B is a sectional view of the connection box as seen from the plane indicated by the line 6B-6B in FIG. 6A;

FIG. 6C is a sectional view as seen from the plane indicated by the line 6C-C in FIG. 6B;

FIG. 7 is an exploded view of a prefilter assembly constructed in accordance with the preferred embodiment of the invention;

FIG. 8 is a top plan view of the prefilter assembly;

FIG. 9 is a sectional view of the prefilter assembly; and,

FIG. 10 is a perspective, exploded view, of a elbow/fitting forming part of the prefilter assembly.

### THE BEST MODE FOR CARRYING OUT THE INVENTION

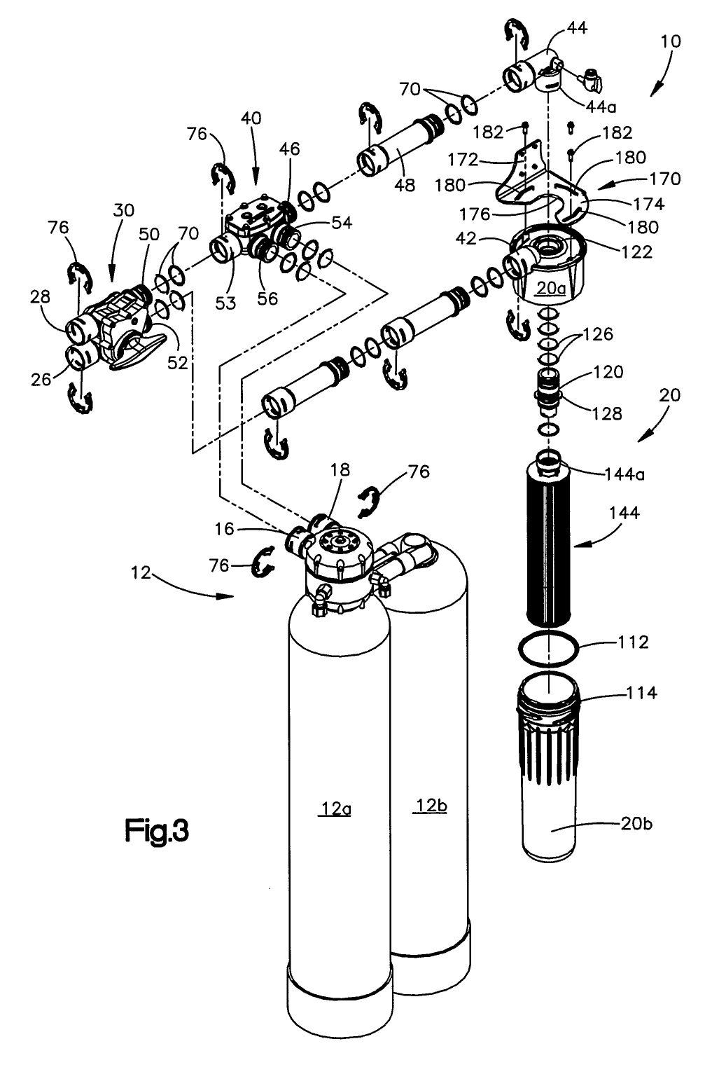

FIG. 1 illustrate one configuration of a water treatment apparatus 10 constructed in accordance with a preferred embodiment of the invention. In the illustrated embodiment, the overall apparatus includes a water treatment unit 12 which comprises a pair of tanks 12a, 12b interconnected by a control valve 12c. The water treatment unit 12 may take several forms and may for example, be a water softening unit such as disclosed in U.S. Pat. No. 4,298,025, a water deionizer disclosed in U.S. Pat. No. 4,427,549 and/or a water filtering apparatus such as that disclosed in U.S. Pat. No. 4,693,814. All of the above-mentioned patents are hereby incorporated by reference. The control valve 12c as more fully discussed and explained in one or more of the above-identified patents, controls the communication of water to be treated from a control valve inlet 16 to one or both of the tanks 12a, 12b. The control valve 12c delivers treated water that passes through one or both treatment tanks to an outlet 18 (see also FIG. 3).

According to the invention, a plumbing system is disclosed which facilitates the installation of the water treatment unit 12 and also provides a prefilter 20 for filtering source water or water to be treated prior to entering the water treatment unit 12.

For purposes of explanation, it will be assumed that the water treatment unit 12 is a water softener and is operative to soften water delivered to the system 10 at an inlet connection 26 and delivers filtered and softened water to a delivery port 28. When the water treatment apparatus 10 is to be installed in a residential application, the household water supply as delivered by utility or well (not shown) is connected to the inlet port 26. The outlet port 28 is connected to the household's water distribution system (not shown) so that softened water is delivered throughout the household.

In the illustrated embodiment, the inlet and outlet ports 26, 28 which are connected to the water supply and household distribution system, respectively form part of a bypass valve 30. The bypass valve 30 may be the same or similar to the bypass valve disclosed in pending International Application No. PCT/US03/34379, filed 29 Oct. 2003, and which is hereby incorporated by reference. As is more fully disclosed in the above-referenced patent application, the bypass valve 30 is configurable into various flow arrangements so that for example, the inlet port 26 may be changed to an outlet port and the outlet port 28 may be changed to an inlet port in order to accommodate the pipe connections available at the installation site. As is also more fully disclosed in the above-referenced application, the bypass valve 30 is operative to isolate the water treatment unit 12 from the household supply when it is being serviced. A handle 30a forming part of the bypass valve 30 can be rotated to block all flow to the water treatment unit 12 or to the outlet port 28 or alternately, to directly communicate the inlet port 26 with the outlet port 28 to thereby “bypass” the water treatment unit 12.

The apparatus 10 shown in FIG. 1 not only integrates plumbing connections but also integrates the prefilter 20 so that the incoming water is filtered before entering the water treatment unit 12. The integrated connections between the household water supply (as provided by the ports 26, 28 forming part of the bypass valve 30), the prefilter 20 and water treatment unit 12 are facilitated by a fluid connector box-like element or module 40 which is constructed in accordance with a preferred embodiment of the invention. As will be explained, the connector module 40 allows connections to be made between the household water supply (not shown) and household delivery conduit (also not shown) and the water treatment unit 12 (and prefilter 20) in several orientations which thereby simplifies the connections to the existing household plumbing system.

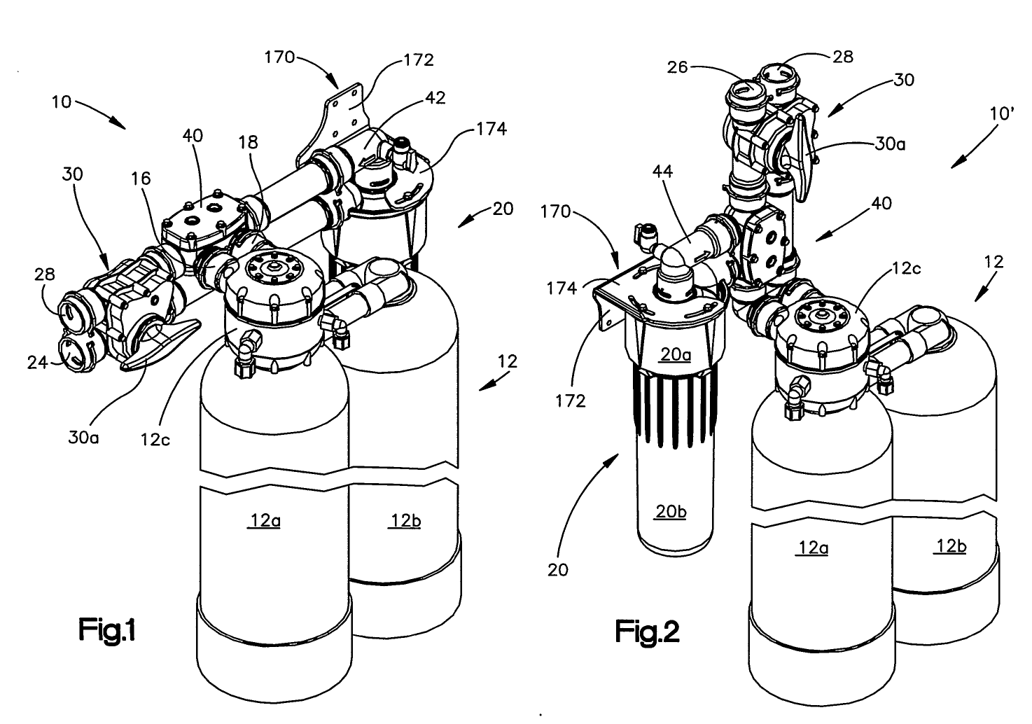

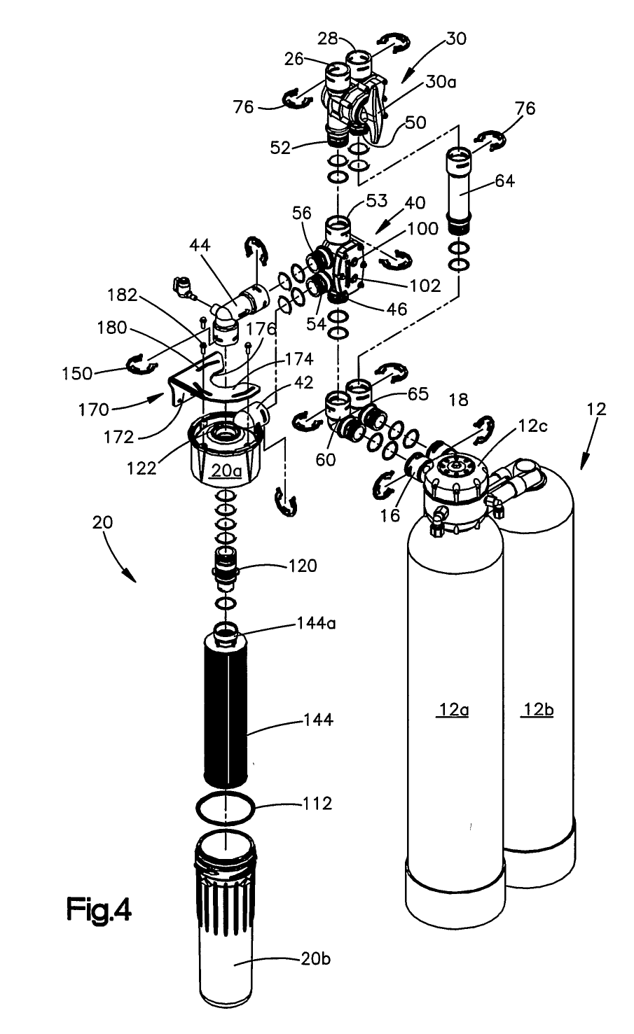

In the configuration illustrated in FIGS. 1 and 3, connections are made to transversely extending household supply and distribution conduits whereas in the system illustrated in FIGS. 2 and 4 the same or similar components are connected to vertically oriented household supply and distribution conduits (not shown).

Referring to FIGS. 1 and 3, the prefilter 20 includes an inlet port 42 and an outlet port 44 (which in the illustrated embodiment is preferably an elbow). As will be explained in more detail below, the connection element 40 is operative to communicate the outlet of the prefilter (via intermediate conduit 48 and connection module port 46) with the inlet port 16 of the water softener control valve 12c. The outlet port 18 of the water softener control valve 12c is fluidly connected by the connection box 40 to a port or connector 50 (shown in FIG. 3) defined by the bypass valve 30. In particular, the control valve outlet port 18 is connected to a connection box port 54. The connection box 40 internally communicates (as will be explained below) the port 54 with a connection box port 53

As more fully described in the above-referenced PCT/US03/34379 patent application the bypass valve port 50 is internally communicated with the bypass valve outlet port 28. In the illustrated configuration, the port 28 as described above is connected to the household water distribution system.

Referring now to FIGS. 2 and 4, the same major components shown in FIG. 1 are repositioned to treat water delivered from a vertically oriented supply conduit (not shown) and to deliver the treated water to a vertically oriented household water supply conduit (also not shown). Other than the orientation of the components, the flow relationships between the prefilter 20 and the water treatment unit 12 are the same. In particular, the bypass valve 30 can be configured so that the port 26 or the port 28 is the inlet and is connected to the source of water to be treated whereas the other of the two ports is configured to deliver treated water to a household supply conduit.

The fluid connection box 40 which is connected to a port 52 on the bypass valve 30 receives water to be treated and communicates it to the prefilter inlet 42 via transfer port 54. The prefiltered water as discharged by the discharge port/elbow 44 is connected to a lateral port 56 on the flow connection box 40. The port 56 is internally communicated with the connection box port 46 that is connected to the inlet port 16 on the control valve 12 via an elbow 60. The outlet 18 of the control valve 12c through which treated water is discharged is connected to the port 50 of bypass valve 30 via a conduit segment 64 and elbow 65. The bypass valve 30 delivers the treated water to its outlet port 28 that is connected to the household water supply (not shown).

In the past, when a water treatment unit 12 was installed, significant time was spent by the installer fabricating plumbing connections between the unit 12 and the existing supply conduits at the site. The time to install a water treatment unit 12 was increased substantially if a prefilter was desired since the plumbing connections between the household conduits and the prefilter as well as the conduit connections between the prefilter and the water treatment unit all had to be fabricated by the installer.

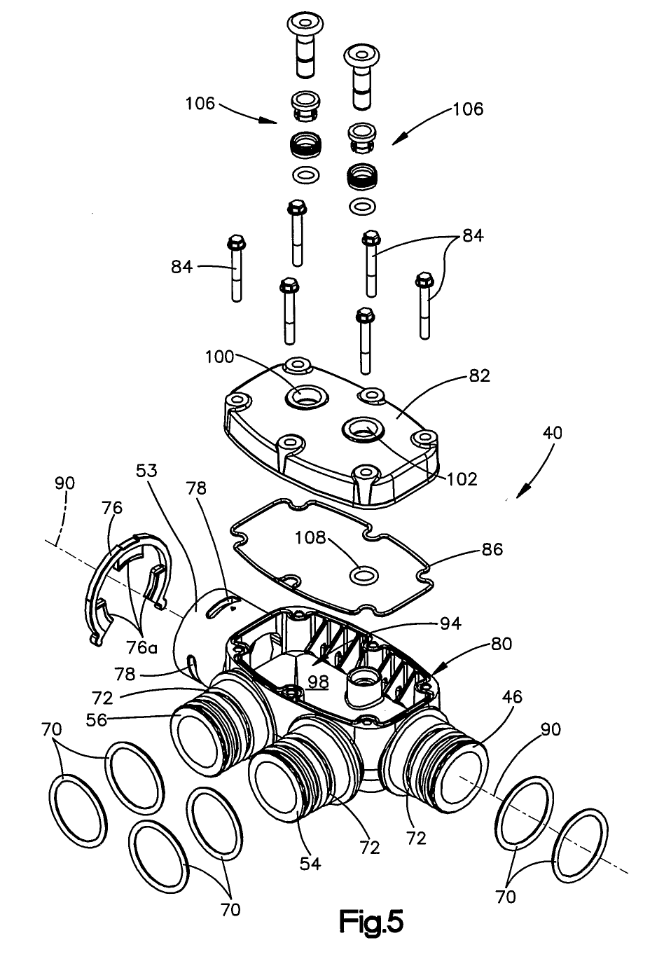

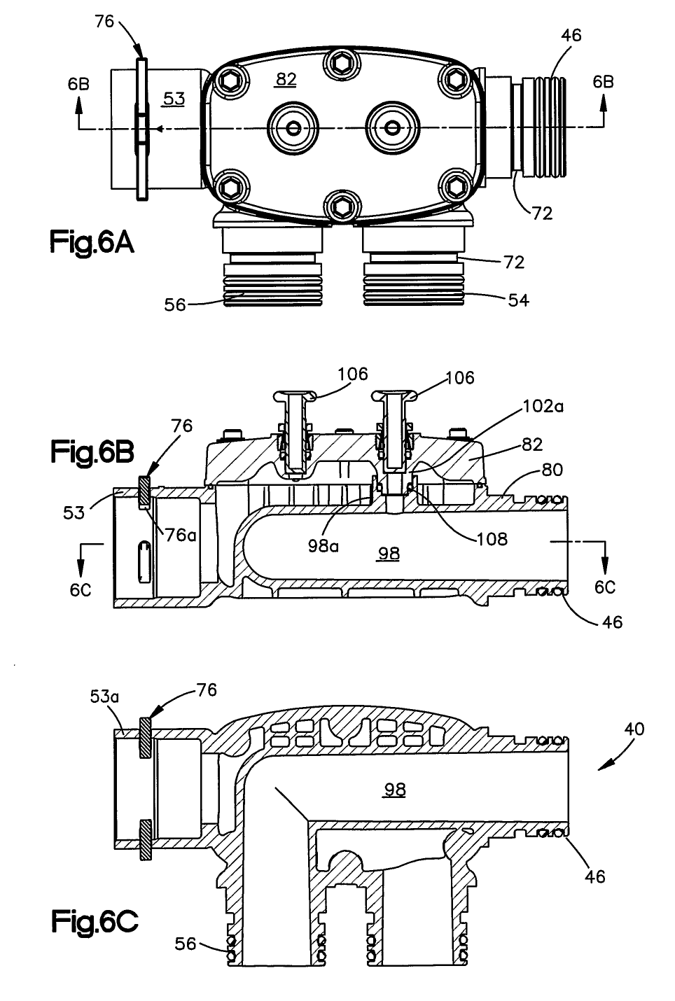

As seen in FIGS. 3, 4 and 5, the interconnections between the various components are facilitated by using “e-ring” type connections. In particular, a male member of the connection for example bypass valve port/connector 50 carries one or more O-rings 70 and also a locking groove 72 (shown best in FIG. 5). When the port/connector 50 is inserted into the female port/connector of the associated component such as the connection box 40, the o-rings 70 sealingly engaged a bore 53a (shown in FIG. 6C) of the female port/connector such as port 53 of the connection box 40 (shown in FIGS. 3 and 5). After the male connector is inserted into position, a resilient e-ring 76 which may be plastic and includes several locking tabs 76a is installed so that the tabs 76a extend through apertures 78 formed in the female connector and engage the locking groove 72 formed on the male connector.

It should be noted here, that the “e-ring” type connectors shown and described above are known. The e-ring type connections illustrated also allow easy disassembly and reorientation of components if needed.

Referring now to FIGS. 5 and 6A-6C, the construction of the connection box 40 is shown. In the preferred embodiment, the connection box 40 includes a molded housing 80 and a cover 82 secured to the housing by a plurality of threaded fasteners 84. A seal or gasket 86 seals the cover 82 to the housing 80. The housing 80 defines a female connector/fitting 53 and three male connectors/fittings 46, 54, 56. In the preferred and illustrated embodiment, the female connector/fitting 53 and the male connector/fitting 46 are positioned so that they lie on a common axis 90. The two remaining male fittings/ports 54, 56 are oriented so their axes are parallel and are orthogonal to the common axis 90 of the fitting/ports 46, 53. In the preferred embodiment, the spacing of the lateral ports 54, 56 corresponds to the spacing defined by the inlet and outlet ports 16, 18 of the control valve 12c so that for certain configurations, the ports 54, 56 of the connection box 40 are connected directly to the ports 16, 18 defined by the control valve 12c without the need for intermediate conduits. This configuration is shown in FIGS. 1 and 3.

The connection box module defines the fluid communication between the molded ports 46, 53, 54, 56. In particular, the female port 53 is communicated with the lateral port 54 by means of a chamber 94 defined between the cover 82 and an interior portion of the housing 80. The lateral port 56 is communicated with the axial male port 46 by means of an integrally molded cross passage 98 (shown best in FIGS. 5 and 6C).

According to a feature of the invention, the cover 82 provides a means for making fluid connections to the interior chamber 94 and/or the integrally molded fluid passage 98. In particular, the cover 82 includes a pair of auxilary ports 100, 102 (shown best in FIG. 5) which may be sealed by removable plug assemblies 106 (see also FIG. 6B). The port 100 communicates with the interior 94 of the housing 80 whereas the port 102 communicates with the internally molded passage 98. This latter communication is established by a fitting 98a that is integrally molded with the internal passage 98 and is sealingly communicated with a depending stub-like connector 102a that is integrally molded with the cover 82 (shown best in 6B). An O-ring 108 (shown best in FIG. 5) seals the stub connector 102a to the fitting 98a. The ports 100, 102 have several uses. For example, pressure gauges may replace the plugs 106 and the inlet and outlet pressures can be monitored. The gauges may be used to monitor pressure drop between the passages 94, 98. Alternately, fluid connections to other water treatment devices such as a reverse osmosis unit or a tank (not shown) can also be made by connecting a suitable conduit to the appropriate port. The apparatus configuration determines what type of water is available for the auxiliary device. In particular, in the configuration shown in FIGS. 1 and 3, the connection box 40 communicates with the outlet of the prefilter 20 via the fitting 46 and the outlet 18 of the control valve 12c via the fitting 54. In this configuration, the port 100 communicates with the treated fluid discharged by the control valve 12c; whereas the port 102 communicates with filtered water discharged by the prefilter 20.

When the apparatus is configured as seen in FIGS. 2 and 4, the connection box port 53 communicates with source water delivered by the bypass valve 30 to the port 53. The control box 40 also communicates with the output of the prefilter 20 via the lateral port 56. Thus, in this configuration, the port 100 communicates with source water; whereas the port 102 communicates with filtered water discharged by the prefilter. As indicated above, the ports may be communicated with an auxiliary treatment device, such as a reverse osmosis system and may serve as a source water supply for the reverse osmosis system. For that type of application, prefiltered or treated water would be communicated to the RO unit. The ports 100, 102 of the connection box 40 may also be used to supply pressure to a pressure operated storage device, such as a storage tank of the type disclosed in U.S. Pat. No. 6,764,595, which is also hereby incorporate by reference.

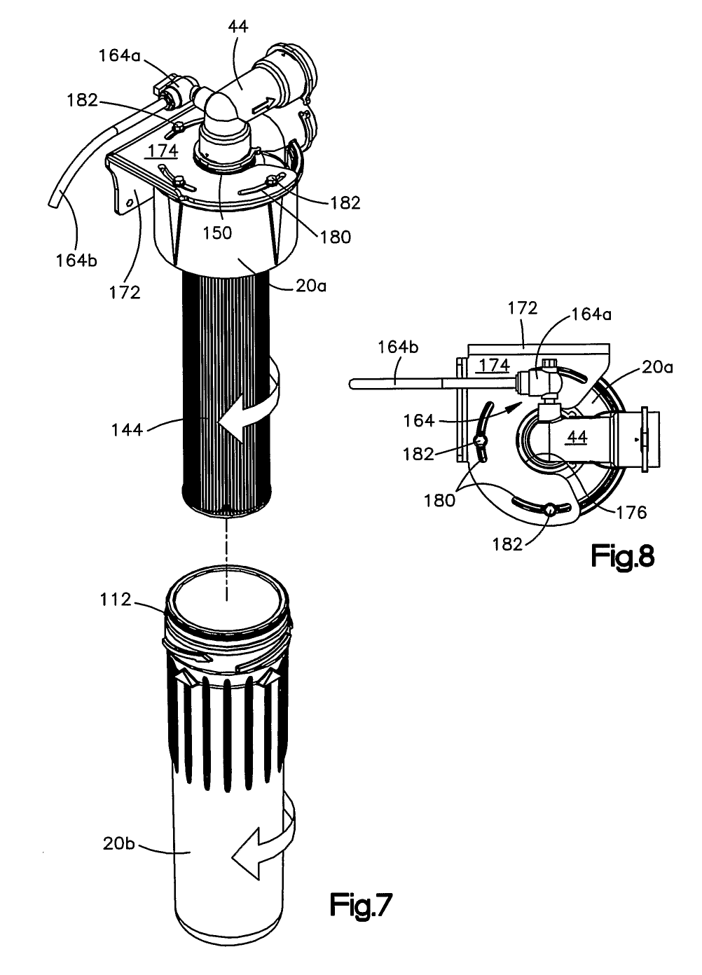

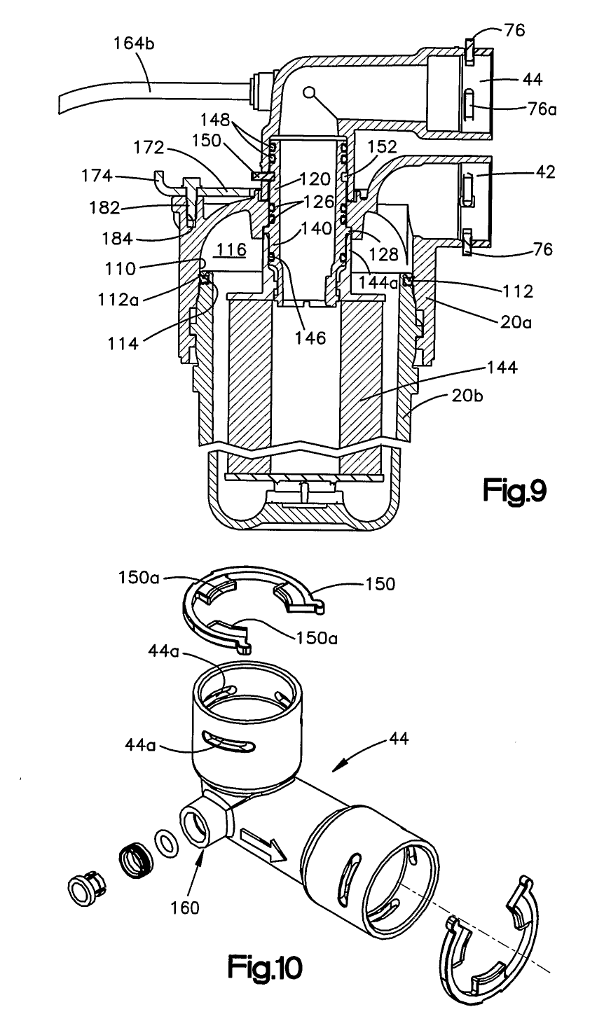

Turning now to FIGS. 7, 8 and 10, the prefilter assembly 20 comprises a filter housing defined by a head 20a and a sump 20b which is removably secured to the head 20a by a thread arrangement which is more fully disclosed in co-pending U.S. Ser. No. 10/847,725, filed May 17, 2004, and which is hereby incorporated by reference. Referring also to FIGS. 8 and 9, the sump 20b sealingly engages an inside sealing surfaced 110 defined by the head (best shown in FIG. 9). In the preferred and illustrated embodiment, the sealing engagement is provided by a cup seal 112 which is held in an associated groove 114 formed in the sump 20b. In this embodiment, an upwardly extending lip 112a of the cup seal 112 (as seen best in FIG. 9) is positioned so that during operation, water pressure in a filter chamber 116 tends to urge the lip 112a radially outwardly to increase the sealing engagement with the chamber wall 110. By using a cup seal rather than an O-ring, friction between the seal 112 and the seal engaging surface 110 is substantially less than would be generated by an O-ring seal, in the absence of water pressure. The cup seal 112 facilitates rotation of the sump 20b relative to the head 20b when the prefilter assembly 20 is not connected to source of water to be treated and thus is unpressurized or at a predetermined lower fluid pressure.

As seen best in FIG. 9, the head 20a mounts a removable adapter 120 which is sealingly fitted within a bore 122 (see FIG. 3) molded into the head. The adapter 120 includes several O-ring grooves that mount O-rings 126 for sealingly engaging the inside of the bore 122 (shown best in FIG. 9). In the preferred embodiment, the adapter 120 includes an integrally molded flange 128 that is non-circular, i.e. square, and which is adapted to be received in a complimentary shaped recess formed in the head 20a. The flange 128 engages the recess when the adapter 120 is fully inserted into the filter head 20a and prevents or inhibits relative rotation between the adapter 120 and the filter housing head 20a.

The adapter 120 defines a filter receiving coupling portion or nose 140, at its lower end. The coupling nose may include threads as more fully described in the above-identified '725 application which are engaged by complimentary shaped threads formed on the inside of a filter neck 144a of a replaceable filter 144. The coupling nose 140 mounts an O-ring 146 in an associated O-ring groove which is sealingly engaged by the filter neck 144a when the filter 144 is installed.

The upper end of the adaptor 120 (as viewed in FIG. 9) defines a male connector that is sealingly engageable by the outlet/elbow 44. The connector includes multiple O-rings 148 held in associated O-ring grooves which sealingly engage an inside bore of the elbow connector 44. An e-ring 150 similar to that described above, is removably engageable with a locking groove 152 formed in the adapter and secures the elbow 44 to the adapter 120. Referring to FIG. 10, the elbow 44 includes suitable apertures/slots 44a which enable locking tabs 150a on the e-ring 150 to engage the groove 152. These slots 44a are best shown in FIG. 10. In accordance with the invention and as best seen in FIG. 10, a fitting or fluid connection 160 is integrally molded into the elbow 44. The fitting 160 can be configured, as one option, to mount a valve and conduit 164 (shown in FIGS. 7 and 8) which are used to depressurize the filter housing 20 when the sump 20b and the filter 144 are to be removed. As should be apparent, the valve 164a is opened to release water from the prefilter assembly 20 and discharge it to a drain or other receptacle via the fluid line 164b in order to depressurize the filter chamber defined by the prefilter assembly. Once depressurized, the sump 20b can be removed by rotating it with respect to the head 20a through a predetermined angle so that the associated threads are released. Once the sump 20b is removed, the filter 144 can then also be disengaged from the head 20a and replaced.

In the preferred and illustrated embodiment, a bracket 170 is disclosed for mounting the prefilter 20 which facilitates the various plumbing configurations that the invention is intended to fulfill. As seen in FIGS. 3, 7 and 8, the bracket 170 is generally L-shaped in configuration and includes a vertical plate member 172 connected to a laterally extending plate member 174. The laterally extending plate member includes a cutaway or slot 176 that provides clearance for the upper end of the adaptor 120 which extends from the bore 122 of the prefilter head 20a. The bracket 170 also includes three spaced apart arcuate slots 180. Fasteners 182 extend through the slots and engage bores 184 in the prefilter head 20 which secure the prefilter to the bracket 170. The slots 180 allow the prefilter to rotate slightly to accommodate the orientation of the plumbing connections and, thereby, facilitate installation. In addition, the bracket 170 can be installed with the vertical plate member 172 directed downardly or upwardly. In FIG. 3, the vertical plate portion 172 extends upwardly; whereas in the configuration shown in FIG. 4, the vertical plate member 172 of the bracket 170 extends downwardly. The ability to install the bracket 170 in either of these two configurations further facilitates installation because it allows the prefilter to be mounted with the connections in various orientations. Finally, and referring to FIGS. 7, 8 and 10, the disclosed fitting/elbow 44, combined with the above-described E-ring type connection, allows the fitting 44 to be rotated or swivelled on the adaptor 120 to also accommodate various plumbing orientations.

In the preferred and illustrated embodiment, the spacing between ports of certain devices are selected to be identical or similar. In particular, the center to center spacing of the prefilter ports 42, 44, the bypass valve ports 50, 52, the control valve ports 16, 18 and the connection box ports 54, 56 are substantially identical. By having a common spacing dimension for these ports, the alternative orientations and connections disclosed in the Figures can be easily achieved. In the illustrated embodiment, the spacing between these pairs of ports is approximately 2.5″.

The present invention thus provides an extremely flexible water treatment apparatus which can be configured to accommodate existing plumbing connections at the installation site. Because all the parts are prefabricated, a kit of parts can be supplied from which the installer chooses those components needed to install the apparatus at the site. It should also be noted here that to facilitate the explanation, the apparatus has been described as being installed in a residence or part of a household supply. It should be understood that the principals of this invention can be applied to other types of installations, including commercial installations of water treatment apparatus 10, 10′.

Although the application has been described with a certain degree of particularity, it should be understood that those skilled in the art can make various changes to it without departing from the spirit or scope as hereinafter claimed.

We claim:

1. Apparatus for connecting a water treatment unit to a plumbing system, comprising:
a) a control valve for controlling the operation of the water treatment unit, said control valve having spaced apart inlet and outlet ports;
b) a filter unit having spaced apart inlet and outlet ports, the spacing and configuration of said filter unit inlet and outlet ports corresponding to the configuration and spacing of said control valve inlet and outlet ports;
c) a connection element for establishing fluid communication between said filter unit and said control valve, said connection box defining first and second isolated flow passages, said first flow passage extending between first and second external ports and said second flow passage extending between third and fourth external ports, said first and third external ports configured and oriented to correspond to the configuration and spacing of said control valve inlet and ports.

2. The apparatus of claim 1, further comprising a bypass valve having at least two ports configured and oriented to correspond to the configuration and spacing of said control valve inlet and ports.

3. The apparatus of claim 1, wherein said connection element includes structure for releasably coupling said first and third ports to said filter unit or said water treatment unit.

4. Apparatus for connecting a water treatment unit to a plumbing system, comprising;
a) a bypass valve for controlling the communication of water to be treated to the water treatment unit and for controlling the communication of treated water to the plumbing system, said bypass valve having spaced apart water input and water output ports;
b) a prefilter having spaced apart inlet and outlet ports, the spacing and configuration of said inlet and outlet ports corresponding to the configuration and spacing of said bypass valve input and output ports;
c) a connection element for establishing fluid communication between said prefilter, said connection box defining first and second isolated flow passages said first flow passage extending between first and second external ports and said second flow passage extending between third and fourth external ports said first and third external ports configured and oriented to correspond to the configuration and spacing of said prefilter ports.

5. The apparatus of claim 4, further comprising a control valve for controlling the operation of the water treatment unit, said control valve having spaced apart inlet and outlet ports, said control valve inlet and outlet ports configured and oriented to correspond to the configuration and spacing of said first and third connection element ports

6. Apparatus for connecting a water treatment unit to a plumbing system, comprising
a) a control valve for controlling the operation of the water treatment unit having spaced apart inlet and outlet ports;
b) a bypass valve for controlling the communication of water to be treated to the water treatment unit and for controlling the communication of treated water to the plumbing system, said bypass valve having spaced apart water input and water output ports;
c) a connection element for establishing fluid communication between said bypass valve and said control valve, said connection element defining first and second isolated flow passages said first flow passage extending between first and second external ports and said second flow passage extending between third and fourth external ports said first and third external ports configured and oriented to correspond to the configuration and spacing of said control valve inlet and outlet ports.

7. The apparatus of claim 6, further comprising a filter unit having spaced apart inlet and outlet ports, the spacing and configuration of said filter inlet and outlet ports corresponding to the configuration and spacing of said control valve inlet and outlet ports.

8. The apparatus of claim 6 wherein said connection element includes at least one auxiliary port communicating with one of said first or second flow passages.

9. The apparatus of claim 6 wherein said connection element includes first and second auxiliary ports that communicate with said first and second flow passages, respectively.

10. The apparatus of claim 9 where in one of said first or second auxiliary ports serves as a source connection for a reverse osmosis unit.

11. The apparatus of claim 9 wherein at least one of said auxiliary ports serves as a connection point for a pressure gauge.

12. A connection module for establishing fluid communication between a water treatment control valve having spaced apart inlet and outlet ports and another device forming part of a water treatment system, said connection module comprising;
a) a housing defining first and second isolated flow passages, said first flow passage extending between external first and second ports and said second flow passage extending between third and fourth external ports;
b) said first and third ports being spaced apart and oriented to correspond to the configuration and spacing of said control valve inlet and outlet ports;
c) said second and fourth ports oriented such that said second and fourth ports lie on coincident axes.

13. The connection module of claim 12 wherein said first and third ports lie on axes that are substantially orthogonal to the axes of said second and fourth ports.

14. The connection module of claim 12 further comprising first and second auxiliary ports that communicate with said first and second flow passages, respectively.

15. The connection module of claim 12 wherein at least some of said external ports have structure for releasably coupling said ports to said other device.

16. The apparatus of claim 15 wherein said other device comprises a prefilter having inlet and outlet ports that are configured and oriented to correspond to the control valve inlet and outlet ports.

17. The apparatus of claim 12 wherein said control valve comprises a bypass valve.

18. A filter unit for a water treatment system, comprising;
a) a filter head including inlet and outlet ports;
b) a sump releasably coupled to said head, said sump at least partially defining a filter chamber when said sump is coupled to said head;
c) a replaceable filter element enclosed located in said filter chamber;
d) a cup seal for sealing the interface between said head and said sump, said cup seal including a lip that is urged into sealing engagement by water pressure within said filter chamber.

19. The filter unit of claim 18 wherein said lip is arranged such that said water pressure in said filter chamber tends to urge said lip radially outwardly in order to increase the sealing engagement with a filter chamber wall.

20. The filter unit of claim 18 wherein said filter inlet and outlet ports are chosen such that the configuration and spacing of said ports corresponds to the configuration spacing of ports defined by at least one other device in a water treatment system.

21. The filter unit of claim 20 wherein said other device comprises a connection module.

22. The filter unit of claim 20 wherein said other device comprises a control valve forming part of said water treatment system.

23. The apparatus of claim 9 wherein both of said auxiliary ports serve as a connection point for associated pressure gauges, said pressure gauges being used to monitor the pressure drop between said first and second flow passages.

24. The filter of claim 20 wherein at least one of said inlet and said outlet ports is swivelly connected to said head.

25. The filter unit of claim 19 wherein said lip reduces its sealing engagement with said filter chamber wall at predetermined low water pressures to enable said sump to be decoupled from said head using hand manipulation.
